(19) United States
(12) Patent Application Publication
(10) Pub. No.: US 2007/0147185 A1
(43) Pub. Date: Jun. 28, 2007

(54) Timepiece

(76) Inventors: Haruki Hiranuma, Chiba-shi (JP); Kinshuro Itoh, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/635,469

(22) Filed: Dec. 7, 2006

(30) Foreign Application Priority Data
Dec. 26, 2005 (JP) 2005-372822

(51) Int. Cl. G04B 37/00

(52) U.S. Cl. 368/311

(57) ABSTRACT

To provide a timepiece in which it has been made possible to exchange an edge member, to which a glass has been fixed, without accompanying a case band. A wristwatch comprises an annular case band, a case back, an annular edge member, a glass, and a C-shaped spring member. A front side end part of the case band forming a fitting hole has an edge receiving face around the fitting hole and an engaging groove. The case back is detachably attached to a back side end part of the case band. The glass is fitted and fixed to an annular step part having been formed in the edge member. In the edge member there are provided a tubular part fitted to the fitting hole so as to be capable of being inserted and disengaged, and a cover part overlapping with the edge receiving face. In the tubular part there are provided an annular attaching groove opening to an inner periphery of the tubular part, and plural through-holes communicating with the annular attaching groove and opening to an outer periphery of the tubular part. The spring member has plural catching convex parts catching to the engaging groove through the through-hole. By detachably attaching this spring member to the attaching groove under a state that the case back 31 has been detached, the edge member is detachably attached to the case band.

### BACKGROUND OF THE INVENTION

1. Field of the Invention

The present invention relates to a timepiece such as a portable watch like, e.g., wristwatch and pocket watch, a desk clock and a wall-mounted clock.

2. Description of the Prior Art

Hitherto, among wristwatches possessing a case back, there is known a wristwatch in which an annular protrusion part is formed in an inner periphery of a front side end part of a case band in which a dial is accommodated, to the inner periphery of this annular protrusion part there are fitted and fixed a glass covering the dial and fitted a tubular part of an edge member functioning also as a bezel, and a caulking part integral with this tubular part has been caulked to a back face of the annular protrusion part (for example, refer to JP-UM-B-5-37273, Gazette).

In the wristwatch in which the edge member has been caulked to the case band as mentioned above, since the fact that a caulked part having been deformed is caulked again after having been returned to a state before being caulked extremely decreases a mechanical strength of the caulked part, it is impossible to detach the edge member from the case band. For this reason, in a case where the edge member has been impaired, a user of the wristwatch is obliged to exchange not only the edge member to which the glass has been fixed but also to exchange it together with the case band to which this edge member has been caulked.

Further, in a wristwatch in which a waterproofness has been intended by nipping a seal packing between the case band and the edge member, there is considered the fact that a performance of the seal packing decreases during a long period guarantee term of the wristwatch and thereafter. Also in a case where, in order to cope with this, it is attempted to exchange the seal packing, since it is impossible to detach the edge member from the case band, it is obliged to exchange not only the edge member but also to exchange it together with the case band to which this edge member has been caulked.

### SUMMARY OF THE INVENTION

An object of the present invention is to provide a timepiece in which it has been made possible to exchange the edge member to which the glass has been fixed, without accompanying the case band.

The present invention comprises an annular case band which has a front side end part forming a fitting hole, and in which this end part has an annular engaging groove opening to the fitting hole together with an edge receiving face around the fitting hole, a case back having been detachably attached to a back side end part of the case band, an annular edge member which has a tubular part fitted so as to be capable of being inserted into and disengaged from the fitting hole and a cover part overlapped with the edge receiving face, and in which, in the tubular part, there has been formed an annular attaching groove opening to an inner periphery face of the tubular part, and there have been formed plural through-holes communicating the fitting groove and the engaging groove under a state that the tubular part has been fitted to the fitting hole, a glass having been fitted and fixed to an annular step part having been formed in the edge member, and a C-shaped spring member which is detachably attached to the attaching groove under a state that the case back has been detached, and which has plural catching convex parts caught to the engaging groove through the through-hole.

In the present invention, the front side end part of the case band may protrude into an inner hollow part of the case band, or may not protrude. In the present invention, the edge receiving face may be provided continuously so as to bulge from a front side open end of the fitting hole to its periphery, or may be provided by forming a step between it and the front side open end such that the front side open end and the edge receiving face exist in different height positions about a thickness direction of the case band. Further, the edge receiving face and a contact face, of the cover part, contacting with the former are not limited to a plane along a direction perpendicularly intersecting with a thickness direction of the case band, and may be formed by a slant face along a direction slantingly intersecting with the thickness direction of the case band or a curved face curving along the direction slantingly intersecting with the thickness direction of the case band.

In the present invention, the outer periphery of the tubular part and the fitting hole into which this tubular part is inserted may be a circular shape or a polygonal shape. In the present invention, a fixation of the glass to the annular step part of the edge member may be fixed by using an adhesive, or pressure-inserting the glass to the annular step part with a seal ring having an elasticity being nipped between it and the annular step part. In the present invention, the spring member of the C-shaped form or the like can be suitably used by a metal spring wire material or the like. Together with this, a sectional shape of the spring member may be a circular shape or a quadrangular shape.

In the present invention, a state that the cover part of the edge member has been overlapped with the edge receiving face of the case band by the fact that the tubular part of the edge member to which the glass has been fixed is inserted into the fitting hole of the case band, is held by the C-shaped spring member which is accommodated in the attaching groove of the tubular part having been disposed in the case band, and which has plural catching convex parts caught to the engaging groove of the front side end part of the case band through the through-hole of the tubular part, and this spring member can be attached/detached under a state that the case back has been opened. For this reason, in a case where the edge member has been impaired or the like, the edge member can be attached to and detached from the case band by attaching/detaching the spring member. Accordingly, the edge member to which the glass has been fixed can be exchanged without accompanying the case band.

In a preferred mode of the present invention, there is possessed an annular seal packing having been nipped between the edge receiving face and the cover part under a compressed state. Here, the seal packing may be provided by annularly forming a holding groove in either of the edge receiving face and the cover part and fitting it to this holding groove, or also can be provided without forming such a holding groove.

In this preferred mode, as already mentioned, since an incorporation and a separation of the edge member with respect to the case band can be performed by the attachment/detachment of the spring member, in a case where a performance of the seal packing bearing a waterproofness/dustproofness between the edge receiving face and the cover part has decreased, it is possible to exchange this packing without accompanying at least the case band between the case band and the edge member.

Additionally, in a preferred mode of the present invention, by protruding at least one end part of the spring member to an inside of the tubular part, it is made an operating part when detaching the spring member from the attaching groove.

In this preferred mode, since the operating part becoming a clue for detaching the spring member is previously protruded to the inside of the tubular member under a state that the spring member has been attached to the tubular part, it is possible, when detaching the edge member from the case band, to pull out the spring member from the attaching groove of the tubular part to the inside of the tubular part while deforming the spring member by grasping the operating part while resisting against the elasticity of the spring member.

Further, in a preferred mode of the present invention, the glass is fixed to the annular step part by an adhesive.

In this preferred mode, since the attachment/detachment of the spring member to/from the tubular part of the edge member is performed without giving an excessive strain to the edge member, there is no fear that the glass is exfoliated with the strain of the edge member being made a cause when attaching/detaching the edge member to/from the case band. Moreover, in addition to the fact that a periphery face of the glass is bonded to an annular periphery face of the annular step part along a thickness direction of the edge member, since a periphery part back face of the glass is bonded to a seat face of the annular step part continuous perpendicularly to the annular periphery face, a bonding area can be largely ensured. For this reason, it is possible to thin a thickness of the edge member while ensuring a necessary bonding area with respect to the glass.

### BRIEF DESCRIPTION OF THE SEVERAL VIEWS OF THE DRAWINGS

A preferred form of the present invention is illustrated in the accompanying drawings in which:

FIG. 1 is a plan view showing a wristwatch concerned with one embodiment of the present invention;

FIG. 2 is a sectional view showing one part of the wristwatch of FIG. 1, while being enlarged;

FIG. 3 is a sectional view showing along an arrow line F3-F3 in FIG. 2;

FIG. 4 is a perspective view showing one part of an edge member that the wristwatch of FIG. 1 possesses, while being seen from an outside;

FIG. 5 is a perspective view showing one part of the edge member that the wristwatch of FIG. 1 possesses, while being seen from an inside; and

FIG. 6 is a perspective view showing a spring member that the wristwatch of FIG. 1 possesses.

### DETAILED DESCRIPTION OF THE PREFERRED EMBODIMENTS

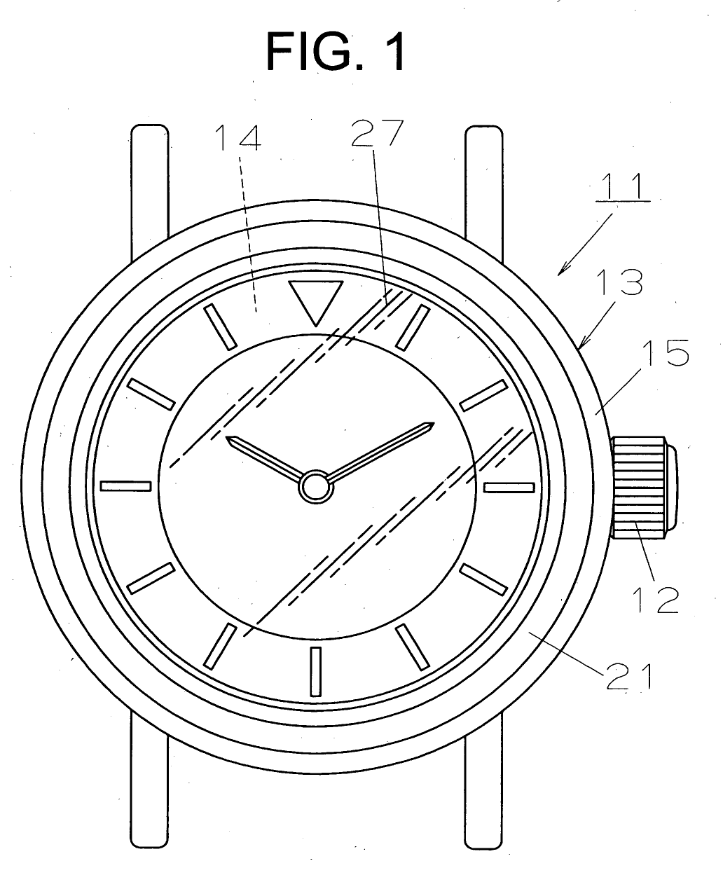

One embodiment of the present invention is explained by referring to FIG. 1-FIG. 6.

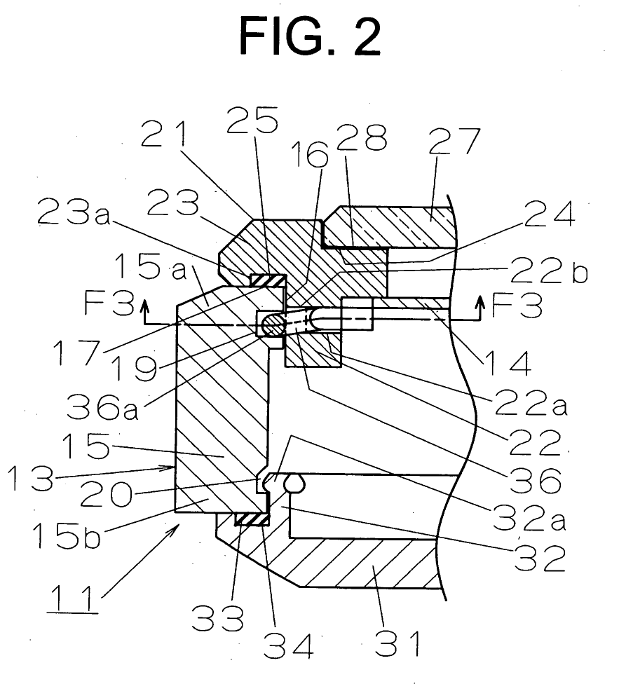

In FIG. 1, a reference numeral 11 denotes a timepiece, e.g., a portable timepiece having possessed a function capable of screw-locking a crown 12, concretely a wristwatch. As shown in FIG. 2, the wristwatch 11 accommodates, in its timepiece armor assembly 13, a dial 14, a timepiece movement not shown in the drawing, and the like. The timepiece movement may be any of one whose power has been made a small battery or a mainspring, or automatically winding one, or one corresponding to a digital timepiece which digital-displays a time instant and the like on the dial 14 by a quartz oscillation module, or one in which the one corresponding to the digital timepiece and one other than it have been used in combination, or the like.

As shown in FIG. 2, the timepiece armor assembly 13 is formed by mounting a glass 27 to a front side of an annular case band 15 through an edge member 21, and liquid-tightly mounting a case back 31 consisting of a metal or the like to a back side of the case band 15.

The case band 15 consists of a metal such as stainless steel and titanium or a synthetic resin. The case band 15 has a front side end part 15a. This front side end part 15a is protruded toward, e.g., an inner hollow part of the case band 15, and a fitting hole 16 is formed in the front side site 15a of the case band 15. The fitting hole 16 is circular for instance.

A surface of the front side end part 15a forms an edge receiving face 17. This edge receiving face 17 is formed by a plane continuous perpendicularly to the fitting hole 16 so as to extend, e.g., from a front side open end of the fitting hole 16 to its periphery. In the front side end part 15a, there is formed an annular engaging groove 19 which opens to an inner periphery face of the front side end part 15a (in other words, which opens to the fitting hole 16).

A locking groove 20 is formed in an inner face of a back side end part 15b of the case band 15. The case back 31 is detachable with respect to the case band 15 from its back side. For this reason, the case back 31 integrally has an in-case-band insertion tubular part 32 which is elastically deformable, and engaging convex parts 32a (only one is shown in the drawing) are formed in several places of a tip part of the in-case-band insertion tubular part 32.

Accordingly, by inserting the in-case-band insertion tubular part 32 into a back face opening of the case band 15, the engaging convex part 32a is caught by a locking groove 20 at the same time as this engaging convex part 32a climbs over a lower side edge of the locking groove 20 while accompanying an elastic deformation of the in-case-band insertion tubular part 32, so that it is possible to mount the case back 31 to the case band 15. Under this attached state, it is possible to detach the case back 31 from the case band 15 by inserting a tip part of a tool such as minus driver not shown in the drawing into a peripheral part of the case back 31 and the back side end part 15b to thereby detach the engaging convex part 32a from the locking groove 20 by wrenching the case back 31. Incidentally, in FIG. 2, a reference numeral 33, denotes an annular seal packing made of a resinous elastic material. The seal packing 33 is nipped under a compressed state by the case band 15 and the case back 31, bears the waterproofness/dustproofness between them, and is fitted and attached, e.g., to a holding groove 34 having been provided in the case back 31.

The edge member 21 is one used as, e.g., a glass edge holding the glass 27, and is annularly formed by the metal such as stainless steel and titanium or the synthetic resin. As shown in FIG. 2 and FIG. 5 or the like, the edge member 21 has integrally a tubular part 22, a cover part 23 and an annular step part 24.

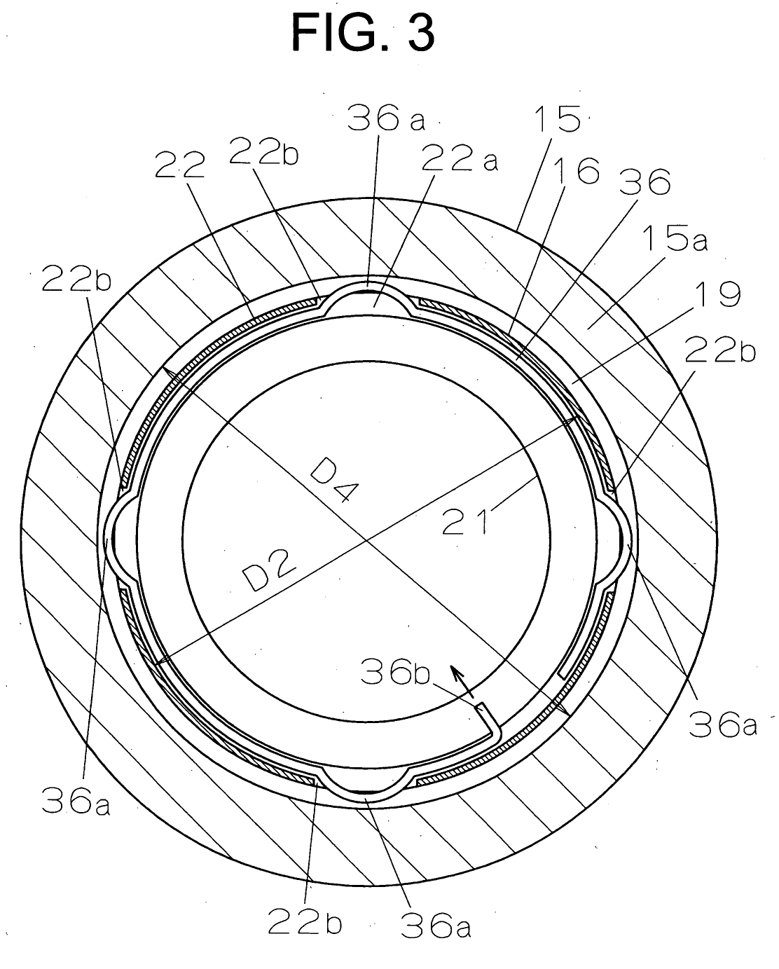

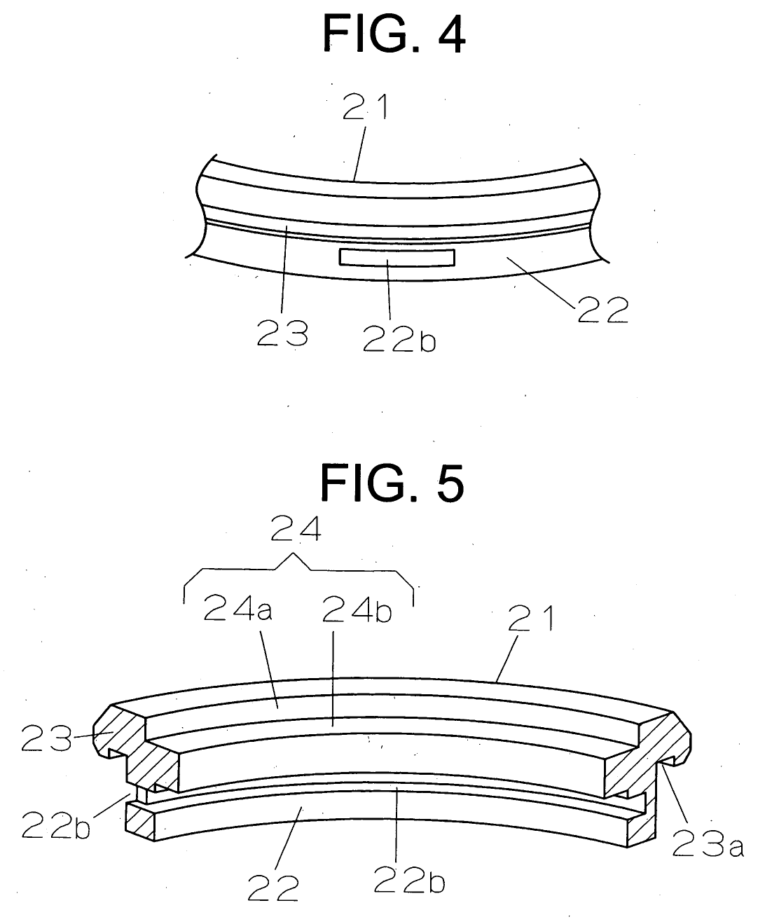

The tubular part 22 is one fitted to the fitting hole 16 so as to be capable of being inserted into and disengaged from the same and, as shown in FIG. 3, forms a cylindrical shape for instance. As shown in FIG. 2, it is desirable that a height of the tubular part 22 is made longer than a thickness of the front side end part 15a of the case band 15. As shown in FIG. 2-FIG. 5, in the tubular part 22, there is formed an annular attaching groove 22a which opens to an inner periphery face of the former, and there are formed plural through-holes 22b. It suffices if the through-holes 22b are provided by 3 to 5, and these are provided in the same interval in a peripheral direction of the tubular part 22. These through-holes 22b are respectively opened to an outer periphery face of the tubular part 22, and respectively opened also to an interior face of the attaching groove 22a. As shown in FIG. 4, each through-hole 22b forms a rectangle which is long in the peripheral direction of the tubular part 22. Additionally, an outer periphery of a tip site extending from the attaching groove 22a to a tip face of the tubular part 22 becomes a taper face in which this tip site is tapered.

The cover part 23 is a site overlapped to the edge receiving face 17 of the front side end part 15a. In a back face of this cover part 23, there is formed an annular holding groove 23a. To this holding groove 23a, there is fitted an annular seal packing 25 (refer to FIG. 2) made of the resinous elastic material. A thickness of the seal packing 25 under its free state is larger than a depth of the holding groove 23a.

As shown in FIG. 5, the annular step part 24 having been provided in an inner periphery side site of the edge member 21 is formed by an annular periphery face 24a and a seat face 24b. The annular periphery face 24a is provided along a thickness direction of the edge member 21, and the seat face 24b is formed continuously, perpendicularly to the annular periphery face 24a. It is desirable that an area of the seat face 24b is larger than an area of the annular periphery face 24a. The glass 27 is fitted and fixed to this annular step part 24 through an adhesive 28 (refer to FIG. 2).

The fixation of the glass 27 to the edge member 21 is performed by fitting the glass 27 to the annular step part 24 after the adhesive 28 has been applied to a corner part that the annular periphery face 24a and the seat face 24b form. By this, the adhesive 28 between the annular step part 24 and a periphery part of the glass 27 is extended along the annular periphery face 24a and the seat face 24b, the periphery face of the glass 27 contacting with the annular periphery face 24a is bonded, and a periphery part back face of the glass 27 contacting with the seat face 24b is bonded to the edge member 21.

The edge member 21 to which the glass 27 has been mounted like this is detachably attached to the case band 15 by using a spring member 36. The spring member 36 is formed in a C-shaped form by a metal-made spring wire material whose section is circular, and integrally has plural catching convex parts 36a and, e.g., one operating part 36b.

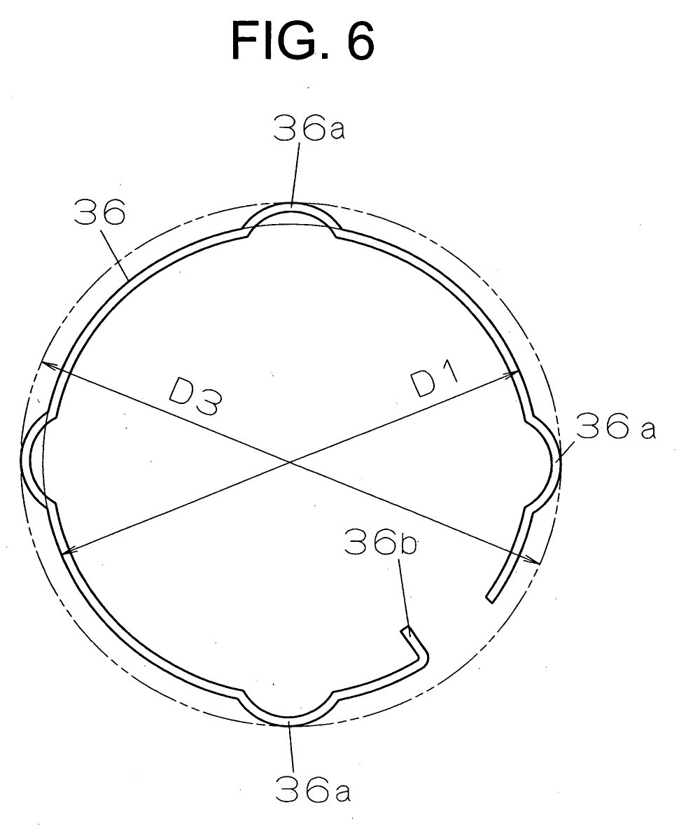

Detailedly, as shown in FIG. 3 and FIG. 6 or the like, the catching convex part 36a is curved, e.g., like an arc in a size capable of passing through the through-hole 22b, and protruded to an outside of the spring member 36 from a center of the spring member 36 toward a radial direction. The operating part 36b is formed by bending one end part of the spring member 36 toward an inside, e.g., the center, of the spring member 36. The operating part 36b may be formed also in the other end part of the spring member 36. A diameter (shown by a sign D1 in FIG. 6) of the spring member 36 under its free state is larger than a diameter (shown by a sign D2 in FIG. 3) passing through an interior face of the attaching groove 22a and, further, an imaginary diameter (shown by a sign D3 in FIG. 6) of the spring member 36 under its free state, which is depicted while passing an apex of each catching convex part 36a, is approximately the same as a diameter (shown by a sign D4 in FIG. 3) passing an interior face of the engaging groove 19.

An attachment/detachment of the edge member 21 to/from the case band 15 is implemented inside the case band 15 as follows under a state that the case back 31 has been detached.

There are explained procedures for attaching the edge member 21, to which the glass 27 and the seal packing 25 have been already incorporated, to the case band 15.

First, the tubular part 22 of the edge member 21 is fitted to the fitting hole 16 of the case band 15 from the front side of the case band 15 and, while compressing the seal packing 25 having been disposed between the edge receiving face 17 of the front side end part 15a and the cover part 23 of the edge member 21, a back face of the cover part 23 is butted against the edge receiving face 17.

By it, the through-hole 22b of the tubular part 22 communicates with and is faced on the engaging groove 19 of the case band 15. In this case, although the engaging groove 19 and the through-hole 22b may be just faced in the same height position, it is desirable, as shown in FIG. 2, to adopt a setting in which the height positions of the attaching groove 22a and the through-hole 22b deviate to a surface side with respect to the engaging groove 19.

Next, with this state being held intact, the spring member 36 is accommodated in the case band 15 from the back face opening of the case band 15, the spring member 36 is fitted to the attaching groove 22a by pushing it to an inner periphery of the tubular part 22 while elastically deforming it so as to reduce its diameter, and is inserted into the engaging groove 19 by passing its catching convex part 36a through the through-hole 22b. On this occasion, in compliance with a necessity, the catching convex part 36a is inserted into the through-hole 22b by moving the spring member 36 in its peripheral direction.

The insertion of the catching convex part 36a into the through-hole 22b like this is performed by a behavior in which the spring member 36 in the attaching groove 22a is restored in a direction along which its diameter is increased by its elastic force and, also after this insertion, the spring member 36 maintains its elastically deformed state. Incidentally, under this state, the operating part 36b of the spring member 36 is protruded to an inside of the tubular part 22 as shown in FIG. 3.

Like the above, since the catching convex part 36a having passed through the through-hole 22b is caught to the engaging groove 19 of the case band 15, the edge member 21 is mounted to the case band 15 as shown in FIG. 2. By this attachment, the glass 27 is faced on the dial 14.

Additionally, as to the spring member 36 under its free state, the catching convex part 36a and a site other than the former exist in the same height positions when seen from a side face direction. On the other hand, as already mentioned, the attaching groove 22a and the through-hole 22b as well as the engaging groove 19 deviate in the height direction. With these being made a cause, under a state that the edge member 21 has been attached to the case band 15 by using the spring member 36, with the catching convex parts 36a having been caught to the engaging groove 19 as shown in FIG. 2 being made supporting points, the spring member 36 is elastically deformed to a state in which a site other than these convex parts is located in an upper side. By this, the edge member 21 is biased in a back side direction of the case band 15 by a force by which the spring member 36 attempts to flatly restore. Accordingly, an attaching state of the edge member 21 to the case band 15 can be more stabilized, and a compressed state of the seal packing 25 is additionally strengthened, so that a liquid tightness between the edge member 21 and the case band 15 can be more ensured.

Next, there are explained procedures for detaching the edge member 21 from the case band 15.

By inserting a tool (not shown in the drawing) from the back face opening of the case band 15 under a state that the case back 31 has been detached and grasping the operating part 36b of the spring member 36 by this tool, this operating part 36b is moved in a direction shown by an arrow mark in FIG. 3. By it, since the spring member 36 is elastically deformed so as to decrease its diameter and each catching convex part 36a of this spring member 36 is pull-moved to an inside of the tubular part 22, it is possible to detach the spring member 36 also from the attaching groove 22a of the tubular part 22 by detaching the catching convex part 36a from the engaging groove 19 of the case band 15. Like this, since the holding of the edge member 21 with respect to the case band 15 is released, it is possible thereafter to detach the edge member 21 by drawing out it from the case band 15.

According to the detachment procedures of the edge member 21 like this, since it is unnecessary to detach the edge member 21 by wrenching the edge member 21 from the front side of the case band 15, there is no fear that the edge member 21 and the front side end part 15a of the case band 15 are injured.

Since it is possible to attach/detach the edge member 21 to/from the case band 15 as mentioned above, in a case where the edge member 21 and the glass 27 have been impaired, it is possible to exchange the edge member 21 and the glass 27, which are exchange objects, by detaching them from the case band 15 by the already mentioned procedures. Similarly, also in a case where a waterproof/dustproof performance of the seal packing 25 has decreased due to a long period use of the wristwatch 11, after the edge member 21, to which the glass 27 has been fixed, has been detached from the case band 15 by the already mentioned procedures, it is possible to exchange the seal packing 25 which is similarly the exchange object without accompanying the edge member 21, to which the glass 27 has been fixed, and the case band 15. Accordingly, in each of these cases, since it becomes unnecessary to discard at least the case band 15 together with an exchange component, an exchange expense for a repair client can be reduced.

The already-mentioned attachment/detachment of the spring member 36 to/from the tubular part 22 of the edge member 21 is performed without giving an excessive strain to the edge member 21. By this, there is no fear that, when the edge member 21 is attached/detached to/from the case band 15, the strain of the edge member 21 is exerted on a bonding part of the glass 27 and thus the glass 27 is exfoliated. Like this, since an action exfoliating the bonding does not work when attaching/detaching the edge member 21, a thickness of the edge member 21 can be thinned. Accordingly, it is possible to intend to thin the whole of the wristwatch 11. And, even if the edge member 21 is thinned, in addition to the fact that the periphery face of the glass 27 is bonded to the annular periphery face 24a of the annular step part 24 along its thickness direction, since a periphery part back face of the glass 27 is bonded to the seat face 24b of the annular step part 24 and a bonding area of the glass 27 with respect to the edge member 21 can be largely ensured, it is possible to certainly fix the glass 27 to the edge member 21.

Incidentally, in a case where the glass 27 is attached to the edge member 21 with an annular elastic packing being nipped between the periphery face of the glass 27 and the annular periphery face 24a of the annular step part 24 under its compressed state, the seat face 24b of the annular step part 24 cannot be used as a fixing face. For this reason, it is necessary to obtain a necessary glass holding force by increasing a height of the annular periphery face 24a and, therefore, it is obliged to thicken the edge member 21 in comparison with the present embodiment.

According to the present invention, it is possible to provide a time piece in which it has been made possible to exchange the edge member without accompanying the case band in a case where edge member, to which the glass has been fixed, has been impaired, or the like.

What is claimed is:

1. A timepiece comprising:
an annular case band which has a front side end part forming a fitting hole, and in which this end part has an annular engaging groove opening to the fitting hole together with an edge receiving face around the fitting hole;
a case back having been detachably attached to a back side end part of the case band;
an annular edge member which has a tubular part fitted so as to be capable of being inserted into and disengaged from the fitting hole and a cover part overlapped with the edge receiving face, and in which, in the tubular part, there has been formed an annular attaching groove opening to an inner periphery face of the tubular part, and there have been formed plural through-holes communicating the fitting groove and the engaging groove under a state that the tubular part has been fitted to the fitting hole;
a glass having been fitted and fixed to an annular step part having been formed in the edge member; and
a C-shaped spring member which is detachably attached to the attaching groove under a state that the case back has been detached, and which has plural catching convex parts caught to the engaging groove through the through-hole.

2. A timepiece according to claim 1, wherein there has been possessed an annular seal packing having been nipped between the edge receiving face and the cover part under a compressed state.

3. A timepiece according to claim 1, wherein by protruding at least one end part of the spring member to an inside of the tubular part, it has been made an operating part when detaching the spring member from the attaching groove.

4. A timepiece according to claim 1, wherein the glass is fixed to the annular step part by an adhesive.
